(19) United States
(12) Patent Application Publication
(10) Pub. No.: US 2025/0142036 A1
(43) Pub. Date: May 1, 2025

(54) ELECTRONIC DEVICE AND COLOR CALIBRATION METHOD THEROF

(71) Applicant: SAMSUNG ELECTRONICS CO., LTD., Suwon-si (KR)

(72) Inventors: Jaesung PARK, Suwon-si (KR); Jiman KIM, Suwon-si (KR)

(73) Assignee: SAMSUNG ELECTRONICS CO., LTD., Suwon-si (KR)

(21) Appl. No.: 18/972,216

(22) Filed: Dec. 6, 2024

Related U.S. Application Data
(63) Continuation of application No. PCT/KR2024/016168, filed on Oct. 23, 2024.

(30) Foreign Application Priority Data
Oct. 27, 2023 (KR) 10-2023-0145870

(51) Int. Cl. H04N 9/31

(52) U.S. Cl. CPC H04N 9/3194; H04N 9/3182; H04N 9/3185

(57) ABSTRACT

An electronic device including a projection part; a user interface; an illumination sensor; and at least one processor configured to identify whether an external light exists around the electronic device based on an illumination value sensed by the illumination sensor, control the projection part to project an image including a plurality of color patches on a projection surface, perform color calibration of an output image based on whether an external light exists around the electronic device and a color of a color patch among the plurality of color patches selected through the user interface, and control the projection part to project the output image for which the color calibration has been performed.

### CROSS-REFERENCE TO RELATED APPLICATION(S)

This application is a bypass continuation of International Application No. PCT/KR2024/016168, filed on Oct. 23, 2024, which is based on and claims priority to Korean Patent Application No. 10-2023-0145870, filed on Oct. 27, 2023, in the Korean Intellectual Property Office, the disclosures of which are incorporated by reference herein in their entireties.

### BACKGROUND

### 1. Field

The disclosure relates to a projector that performs color calibration of an output image, and a color calibration method thereof.

### 2. Description of Related Art

A projector is a device that projects an image. By implementing an image by projecting a light on a screen, a projector can easily implement a large screen compared to other types of display devices.

Recently, as a projector has an improved performance and has become miniaturized, projectors are being widely used in various places like homes or outdoors, etc.

### SUMMARY

Aspects of embodiments of the disclosure will be set forth in part in the description which follows and, in part, will be apparent from the description, or may be learned by practice of the presented embodiments.

According to an embodiment of the disclosure, an electronic device includes a projection part; a user interface; an illumination sensor; and at least one processor configured to identify whether an external light exists around the electronic device based on an illumination value sensed by the illumination sensor, control the projection part to project an image including a plurality of color patches on a projection surface, perform color calibration of an output image based on whether an external light exists around the electronic device and a color of a color patch among the plurality of color patches selected through the user interface, and control the projection part to project the output image for which the color calibration has been performed.

According to an embodiment of the disclosure, the at least one processor may be configured to, based on identifying that the external light does not exist, control the projection part to project the image including the plurality of color patches on the projection surface in a first brightness, and, based on receiving a user input through the user interface selecting a color patch among the plurality of color patches that is seen by a user in a first color, perform the color calibration of the output image by correcting R, G, B values of the output image based on ratio values of R, G, B values of the selected color patch.

According to an embodiment of the disclosure, the at least one processor may be configured to identify a maximum value among the R, G, B values of the selected color patch, identify the ratio values of the R, G, B values of the selected color patch by dividing the R, G, B values of the selected color patch by the identified maximum value, and correct the R, G, B values of the output image by multiplying the R, G, B values of the output image by the identified ratio values.

According to an embodiment of the disclosure, the first brightness may include a maximum brightness of the electronic device. The first color may include a white color.

According to an embodiment of the disclosure, the at least one processor may be configured to, based on identifying that the external light exists, control the projection part to project the image as a first image including the plurality of color patches on the projection surface in a first brightness, and project the image as a second image including the plurality of color patches on the projection surface in a second brightness, based on receiving a user input through the user interface selecting a first color patch among the plurality of color patches included in the first image that is seen by a user in a first color, identify first ratio values of R, G, B values of the first color patch, based on receiving a user input through the user interface selecting a second color patch among the plurality of color patches included in the second image that is seen by the user in a second color, identify second ratio values of R, G, B values of the second color patch, and perform the color calibration of the output image by correcting the R, G, B values of the output image based on at least one of the identified first ratio values or the identified second ratio values.

According to an embodiment of the disclosure, the first brightness may include a maximum brightness of the electronic device. The second brightness may be lower than the first brightness. The first color may include a white color. The second color may include a gray color.

According to an embodiment of the disclosure, the at least one processor may be configured to identify a first maximum value among the R, G, B values of the first color patch, identify the first ratio values of the R, G, B values of the first color patch by dividing the R, G, B values of the first color patch by the identified first maximum value, identify a second maximum value among the R, G, B values of the second color patch, and identify the second ratio values of the R, G, B values of the second color patch by dividing the R, G, B values of the second color patch by the identified second maximum value.

According to an embodiment of the disclosure, the at least one processor may be configured to identify a first weight and a second weight based on a maximum value among the R, G, B values of the output image, the first maximum value, and the second maximum value, based on the second maximum value being smaller than or equal to the maximum value, perform the color calibration of the output image by correcting the R, G, B values of the output image based on the identified first ratio values to which the first weight was applied and the identified second ratio values to which the second weight was applied, and, based on the second maximum value being larger than the maximum value, perform the color calibration of the output image by correcting the R, G, B values of the output image based on the identified second ratio values.

According to an embodiment of the disclosure, the at least one processor may be configured to, based on receiving a user input through the user interface selecting a color patch among a plurality of first color patches, obtain a plurality of second color patches by adjusting a chroma of the color of the selected color patch among the plurality of first color patches, control the projection part to project an image including the plurality of second color patches on the projection surface, and, based on receiving a user input through the user interface selecting a color patch among the plurality of second color patches, perform the color calibration of the output image based on the color of the selected color patch among the plurality of second color patches.

According to an embodiment of the disclosure, the electronic device may further include a camera. The at least one processor may be configured to control the camera to obtain an image including the projection surface, and identify colors of the plurality of color patches based on colors of the projection surface included in the obtained image.

According to an embodiment of the disclosure, provided is a method of performing color calibration of an electronic device including a projection part, a user interface, and an illumination sensor, the method including identifying whether an external light exists around the electronic device based on an illumination value sensed by the illumination sensor; projecting an image including a plurality of color patches on a projection surface; performing color calibration of an output image based on whether an external light exists around the electronic device and a color of a color patch among the plurality of color patches selected through the user interface; and projecting the output image for which the color calibration has been performed.

According to an embodiment of the disclosure, the projecting the image including the plurality of color patches may include, based on identifying that the external light does not exist, projecting the image including the plurality of color patches on the projection surface in a first brightness. The performing the color calibration may include, based on receiving a user input through the user interface selecting a color patch among the plurality of color patches that is seen by a user in a first color, performing the color calibration of the output image by correcting R, G, B values of the output image based on ratio values of R, G, B values of the selected color patch.

According to an embodiment of the disclosure, the performing the color calibration may include identifying a maximum value among the R, G, B values of the selected color patch, identifying the ratio values of the R, G, B values of the selected color patch by dividing the R, G, B values of the selected color patch by the identified maximum value, and correcting the R, G, B values of the output image by multiplying the R, G, B values of the output image by the identified ratio values.

According to an embodiment of the disclosure, the first brightness may include a maximum brightness of the electronic device. The first color may include a white color.

According to an embodiment of the disclosure, the projecting the image including the plurality of color patches may include, based on identifying that the external light exists, projecting the image as a first image including the plurality of color patches on the projection surface in a first brightness, and projecting the image as a second image including the plurality of color patches on the projection surface in a second brightness. The performing the color calibration may include, based on receiving a user input through the user interface selecting a first color patch among the plurality of color patches included in the first image that is seen by a user in a first color, identifying first ratio values of R, G, B values of the first color patch, based on receiving a user input through the user interface selecting a second color patch among the plurality of color patches included in the second image that is seen by the user in a second color, identifying second ratio values of R, G, B values of the second color patch, and performing the color calibration of the output image by correcting the R, G, B values of the output image based on at least one of the identified first ratio values or the identified second ratio values.

According to an embodiment of the disclosure, provided is a non-transitory computer readable medium including instructions to control a computer to perform a performing color calibration of an electronic device including a projection part, a user interface, and an illumination sensor, the method including identifying whether an external light exists around the electronic device based on an illumination value sensed by the illumination sensor; projecting an image including a plurality of color patches on a projection surface; performing color calibration of an output image based on whether an external light exists around the electronic device and a color of a color patch among the plurality of color patches selected through the user interface; and projecting the output image for which the color calibration has been performed.

### BRIEF DESCRIPTION OF THE DRAWINGS

These and/or other aspects, features, and advantages of embodiments of the present disclosure will become clearer and more readily appreciated through the following descriptions of embodiments, taken in conjunction with the accompanying drawings of which:

FIG. 1 is a diagram for illustrating an electronic device according to an embodiment of the disclosure;

FIG. 2A is a block diagram for illustrating a configuration of an electronic device according to an embodiment of the disclosure;

FIG. 2B is a block diagram for illustrating a configuration of an electronic device according to an embodiment of the disclosure;

FIG. 3 is a diagram for illustrating an example of an image including a plurality of color patches according to an embodiment of the disclosure;

FIG. 4A and FIG. 4B are diagrams for illustrating an example of guiding selection of a color patch to a user according to an embodiment of the disclosure;

FIG. 5 is a diagram for illustrating an example of correcting colors of an output image and outputting the image according to an embodiment of the disclosure;

FIG. 6 is a diagram for illustrating an example of an image including a plurality of color patches according to an embodiment of the disclosure;

FIG. 7A and FIG. 7B are diagrams for illustrating an example of guiding selection of a color patch to a user according to an embodiment of the disclosure;

FIG. 8 is a diagram for illustrating an example of an image including a plurality of color patches according to an embodiment of the disclosure;

FIG. 9A and FIG. 9B are diagrams for illustrating an example of guiding selection of a color patch to a user according to an embodiment of the disclosure;

FIG. 10 is a diagram for illustrating an example of correcting colors of an output image and outputting the image according to an embodiment of the disclosure;

FIG. 11 is a diagram for illustrating an example of providing a color calibration result to a user according to an embodiment of the disclosure;

FIG. 12 is a diagram for illustrating an example of a method of projecting a color patch according to an embodiment of the disclosure;

FIG. 13A and FIG. 13B are diagrams for illustrating an example of a method of projecting a color patch according to an embodiment of the disclosure; and

FIG. 14 is a flow chart for illustrating a color calibration method of an electronic device according to an embodiment of the disclosure.

### DETAILED DESCRIPTION

Hereinafter, the disclosure will be described in detail with reference to the accompanying drawings.

Various modifications may be made to the embodiments of the disclosure, and there may be various types of embodiments. Accordingly, specific embodiments will be illustrated in drawings, and the embodiments will be described in detail in the detailed description. However, it should be noted that the various embodiments are not for limiting the scope of the disclosure to a specific embodiment, but they should be interpreted to include various modifications, equivalents, and/or alternatives of the embodiments of the disclosure. Also, with respect to the detailed description of the drawings, similar components may be designated by similar reference numerals.

Also, in describing the disclosure, in case it is determined that detailed explanation of related known functions or features may unnecessarily confuse the gist of the disclosure, the detailed explanation will be omitted.

In addition, the embodiments below may be modified in various different forms, and the scope of the technical idea of the disclosure is not limited to the embodiments below. Rather, these embodiments are provided to make the disclosure more sufficient and complete, and to fully convey the technical idea of the disclosure to those skilled in the art.

Further, the terms used in the disclosure are used just to explain specific embodiments of the disclosure, and are not intended to limit the scope of the other embodiments. In addition, singular expressions include plural expressions, unless defined obviously differently in the context.

Also, in the disclosure, expressions such as “have,” “may have,” “include,” and “may include” denote the existence of such characteristics (e.g., elements such as numbers, functions, operations, and components), and do not exclude the existence of additional characteristics.

In addition, in the disclosure, the expressions “A or B,” “at least one of A and/or B,” or “one or more of A and/or B” and the like may include all possible combinations of the listed items. For example, “A or B,” “at least one of A and B,” or “at least one of A or B” may refer to all of the following cases: (1) including at least one A, (2) including at least one B, or (3) including at least one A and at least one B.

Further, the expressions “first,” “second,” and the like used in the disclosure may describe various elements regardless of any order and/or degree of importance. Also, such expressions are used only to distinguish one element from another element, and are not intended to limit the elements.

Meanwhile, the description in the disclosure that one element (e.g., a first element) is “(operatively or communicatively) coupled with/to” or “connected to” another element (e.g., a second element) should be interpreted to include both the case where the one element is directly coupled to the another element, and the case where the one element is coupled to the another element through still another element (e.g., a third element).

In contrast, the description that one element (e.g., a first element) is “directly coupled” or “directly connected” to another element (e.g., a second element) can be interpreted to mean that still another element (e.g., a third element) does not exist between the one element and the another element.

Also, the expression “configured to” used in the disclosure may be interchangeably used with other expressions such as “suitable for,” “having the capacity to,” “designed to,” “adapted to,” “made to,” and “capable of,” depending on cases. Meanwhile, the term “configured to” may not necessarily mean that a device is “specifically designed to” in terms of hardware.

Instead, under some circumstances, the expression “a device configured to” may mean that the device “is capable of” performing an operation together with another device or component. For example, the phrase “a processor configured to perform A, B, and C” may mean a dedicated processor (e.g., an embedded processor) for performing the corresponding operations, or a generic-purpose processor (e.g., a CPU or an application processor) that can perform the corresponding operations by executing one or more software programs stored in a memory device.

Also, in the embodiments of the disclosure, ‘a module’ or ‘a part’ may perform at least one function or operation, and may be implemented as hardware or software, or as a combination of hardware and software. In addition, a plurality of ‘modules’ or ‘parts’ may be integrated into at least one module and implemented as at least one processor, excluding ‘a module’ or ‘a part’ that needs to be implemented as specific hardware.

Hereinafter, an embodiment of the disclosure will be described in more detail with reference to the accompanying drawings.

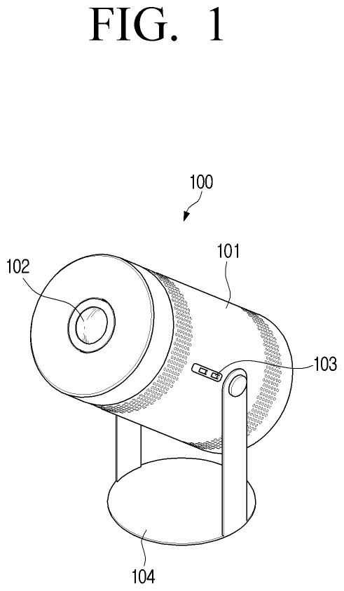

FIG. 1 is a diagram for illustrating an electronic device according to an embodiment of the disclosure.

Referring to FIG. 1, an electronic device 100 may display an output image. The electronic device 100 may be a projector (or a projector device). The projector may be a device that enlarges and projects an output image on a projection surface (e.g., a wall, a screen, etc.). Also, the projector may be a movable projector (or a portable projector) that a user can carry.

A main body 101 may have a cylindrical shape, and support or protect components arranged inside the main body 101. In FIG. 1, it was illustrated that the main body 101 is a cylindrical shape, but the main body 101 is not limited to this example. For example, the main body 101 may have various shapes such as a cuboid, a cube, a sphere, etc.

The main body 101 may be implemented in a small size so that a user can easily grip it. A user can easily carry the electronic device 100.

On the outer circumferential surface of the main body 101, a plurality of openings may be formed. Through the plurality of openings, an audio signal generated at the electronic device 100 may be output to the outside of the main body 101. Also, inside the main body 101, a radiation fan may be provided. When the radiation fan is driven, air or heat inside the main body 101 may be discharged to the outside of the main body 101 through the plurality of openings. Heat generated by the driving of the electronic device 100 may be discharged to the outside, and overheating of the electronic device 100 can be prevented.

A projection lens 102 may be formed in a projection part or on one surface of the main body 101, and project a light that passed through a lens array to the outside of the main body 101. For example, the projection lens 102 may be an optical lens, a convex lens, or a condensing lens. The projection lens 102 may adjust a focus by adjusting locations of a plurality of sub lenses.

A connector 103 may connect the electronic device 100 with an external device and transmit or receive data, or may be supplied with power from the outside.

The support 104 may support the electronic device 100 from the bottom surface on which the electronic device 100 is placed. The support 104 may be rotatably coupled with the main body 101. The user may change an angle in which an image is projected by rotating the main body 101 up/down while the electronic device 100 is placed on the bottom surface.

Meanwhile, as the electronic device 100 is portable, the user may locate the electronic device 100 in a place wherein the user wants to view an image. Accordingly, a case wherein an image is projected on a colored projection surface (e.g., a colored wall, etc.) but not on a dedicated screen for a projector (e.g., a white screen) may frequently occur. In case the color of a projection surface is not white (i.e., in case a projection surface is colored), the color of the projection surface may influence an image projected on the projection surface, and the user may be provided with an image of a different color from the original color.

Also, in case an external light (e.g., a sunlight, a light output from a lighting, etc.) exists in the place wherein the electronic device 100 is located, the external light may also influence the color of an image projected on a projection surface.

In the disclosure, the electronic device 100 may perform color calibration of an image projected on a projection surface in consideration of the color of the projection surface and an external light.

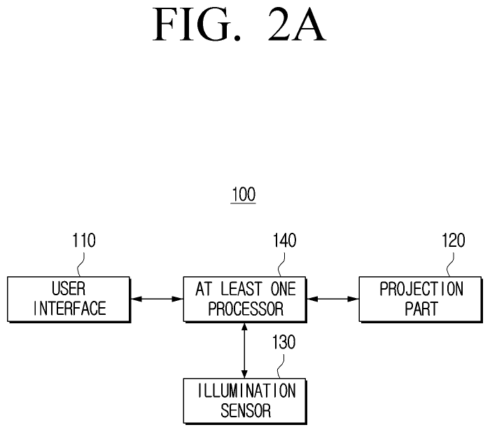

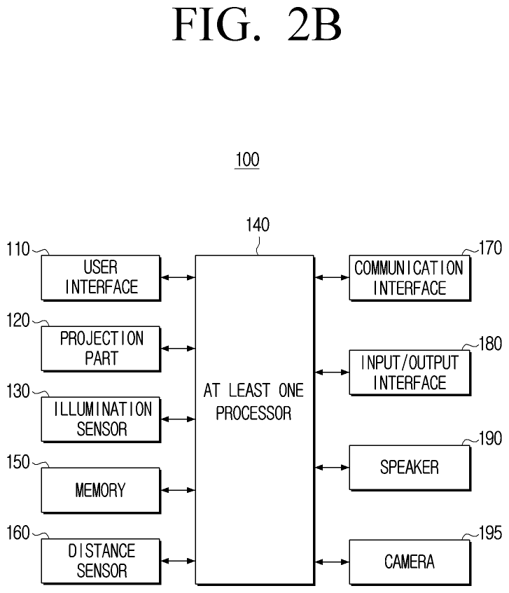

FIG. 2A is a block diagram for illustrating a configuration of an electronic device according to an embodiment of the disclosure.

Referring to FIG. 2A, the electronic device 100 may include a user interface 110, a projection part 120, an illumination sensor 130, and at least one processor 140.

The user interface 110 includes circuitry. The user interface 110 receives a user input. The user interface 110 may transmit the received user input to the at least one processor 140.

The user interface 110 may include various types of input devices.

For example, the user interface 110 may include physical buttons. The physical buttons may include function keys, direction keys, or dial buttons. The physical buttons may be implemented as a plurality of keys. Alternatively, the physical buttons may be implemented as one key. In case the physical buttons are implemented as one key, if a user input by which the key is pushed during a threshold time or longer is received, the at least one processor 140 may perform a function corresponding to the user input.

For example, the user interface 110 may receive a user input by using a touch method. The user interface 110 may include a touch sensor or a touch screen.

For example, the user interface 110 may receive a user input from an external device. The external device may include a remote control device (e.g., a remote control) or a user's mobile device (e.g., a smartphone or a wearable device) for controlling the electronic device 100. In the mobile device, an application for controlling the electronic device 100 may be stored. The mobile device may receive a user input through the application, and transmit the user input to the electronic device 100.

For example, the user interface 110 may receive a user input by using voice recognition. The user interface 110 may receive a user voice by using a microphone. The at least one processor 140 may perform a function corresponding to the user voice. For example, the at least one processor 140 may convert the user voice into text data by using a speech to text (STT) function, and obtain control command data based on the text data, and perform a function corresponding to the user voice based on the control command data. Depending on embodiments, the STT function may be performed at a server.

The projection part 120 is a component that projects an image to the outside. For this, the projection part 120 may include a light source. For example, the projection part 120 may include at least one light source among a lamp, LEDs, or a laser.

The projection part 120 may project an image by using various projection methods. For example, the projection part 120 may project an image by using at least one projection method among a cathode-ray tube (CRT) method, a liquid crystal display (LCD) method, a digital light processing (DLP) method, and a laser method.

The projection part 120 may output an image in various screen ratios according to the use of the electronic device 100 or the user's setting, etc. For example, the projection part 120 may output an image in a screen ratio of 4:3, a screen ratio of 5:4, and a wide screen ratio of 16:9, and output an image in various resolutions such as WVGA (854*480), SVGA (800*600), XGA (1024*768), WXGA (1280*720), WXGA (1280*800), SXGA (1280*1024), UXGA (1600*1200), Full HD (1920*1080), etc. according to screen ratios.

The projection part 120 may perform various functions for adjusting an image by control by the at least one processor 140. For example, the projection part 120 may perform functions such as zoom, keystone, etc.

For example, the projection part 120 may enlarge or reduce an image according to a distance from a projection surface (e.g., a projection distance). That is, a zoom function may be performed according to a projection distance. The zoom function may include a hardware method of adjusting the size of an image by moving a lens and a software method of adjusting the size of an image by a crop, etc. When the zoom function is performed, adjustment of a focus of an image may be needed. For example, methods of adjusting a focus may include a manual focus method and an electric method, etc. The manual focus method means a method of adjusting a focus manually. The electric method means a method wherein, when the zoom function is performed, the projector automatically adjusts a focus by using a motor. For example, the projection part 120 may provide a digital zoom function by using software, or provide an optical zoom function of performing a zoom function by moving the lens.

For example, the projection part 120 may perform a keystone correction function. The keystone correction function means a function of correcting a distorted image. For example, if a distortion of an image occurs in a left-right direction, the projection part 120 may perform a horizontal keystone correction, and if a distortion of an image occurs in an up-down direction, the projection part 120 may perform a vertical keystone correction. Also, in case the corners of an area are out of balance, the projection part 120 may perform a quick corner keystone correction for correcting this.

The illumination sensor 130 may sense illumination around the electronic device 100. The illumination sensor 130 may measure an illumination value around the electronic device 100, and transmit the measured illumination value to the at least one processor 140. For example, the illumination sensor 130 may be implemented as any one of a photo sensor, a cadmium sulfide (CDS) sensor, an ultra violet (UV) sensor, or an ambient light sensor (ALS), but is not limited to these examples.

The at least one processor 140 controls the overall operations of the electronic device 100. Specifically, the at least one processor 140 may be connected with the components of the electronic device 100, and control the overall operations of the electronic device 100. For example, the at least one processor 140 may be connected with the user interface 110, the projection part 120, and the illumination sensor 130, and control the electronic device 100. The at least one processor 140 may consist of one or a plurality of processors.

The at least one processor 140 may perform the operations of the electronic device 100 according to the various embodiments of the disclosure by executing one or more instructions stored in the memory of the electronic device 100.

The at least one processor 140 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The at least one processor 140 may control one or a random combination of the other components of the electronic device 100, and perform an operation related to communication or data processing. Also, the at least one processor 140 may execute one or more programs or instructions stored in the memory. For example, the at least one processor 140 may perform the method according to an embodiment of the disclosure by executing the one or more instructions stored in the memory.

In case the method according to an embodiment of the disclosure includes a plurality of operations, the plurality of operations may be performed by one processor, or performed by a plurality of processors. For example, when a first operation, a second operation, and a third operation are performed by the method according to an embodiment, all of the first operation, the second operation, and the third operation may be performed by a first processor, or the first operation and the second operation may be performed by the first processor (e.g., a generic-purpose processor), and the third operation may be performed by a second processor (e.g., an artificial intelligence-dedicated processor).

The at least one processor 140 may be implemented as a single core processor including one core, or may be implemented as one or more multicore processors including a plurality of cores (e.g., multicores of the same kind or multicores of different kinds). In case the at least one processor 140 is implemented as multicore processors, each of the plurality of cores included in the multicore processors may include an internal memory of the processor such as a cache memory, an on-chip memory, etc., and a common cache shared by the plurality of cores may be included in the multicore processors. Also, each of the plurality of cores (or some of the plurality of cores) included in the multicore processors may independently read a program instruction for implementing the method according an embodiment of the disclosure and perform the instruction, or the plurality of entire cores (or some of the cores) may be linked with one another, and read a program instruction for implementing the method according to an embodiment of the disclosure and perform the instruction.

In case the method according to an embodiment of the disclosure includes a plurality of operations, the plurality of operations may be performed by one core among the plurality of cores included in the multicore processors, or they may be performed by the plurality of cores. For example, when the first operation, the second operation, and the third operation are performed by the method according to an embodiment, all of the first operation, the second operation, and the third operation may be performed by a first core included in the multicore processors, or the first operation and the second operation may be performed by the first core included in the multicore processors, and the third operation may be performed by a second core included in the multicore processors.

In the embodiments of the disclosure, the processor may mean a system on chip (SoC) wherein at least one processor and other electronic components are integrated, a single core processor, a multicore processor, or a core included in the single core processor or the multicore processor. Also, here, the core may be implemented as a CPU, a GPU, an APU, a MIC, a DSP, an NPU, a hardware accelerator, or a machine learning accelerator, etc., but the embodiments of the disclosure are not limited thereto.

FIG. 2B is a block diagram for illustrating a configuration of an electronic device according to an embodiment of the disclosure.

Referring to FIG. 2B, the electronic device 100 may include a user interface 110, a projection part 120, an illumination sensor 130, at least one processor 140, a memory 150, a distance sensor 160, a communication interface 170, an input/output interface 180, a speaker 190, and a camera 195. However, these components are merely exemplary ones, and it is obvious that in implementing the disclosure, new components can be added in addition to such components, or some components can be omitted. Meanwhile, among the components illustrated in FIG. 2B, regarding the components overlapping with the components illustrated in FIG. 2A, detailed explanation will be omitted.

The memory 150 may store data necessary for the electronic device 100 to operate according to various embodiments of the disclosure.

The memory 150 may be implemented as a memory embedded in the electronic device 100 (e.g., a volatile memory, a non-volatile memory, a hard drive, or a solid state drive, etc.), or implemented as a memory that can be attached to or detached from the electronic device 100 (e.g., a memory card, an external memory, etc.) according to the use of the stored data.

In the memory 150, one or more instructions may be stored. The at least one processor 140 may perform the operations of the electronic device 100 according to the various embodiments of the disclosure by executing the one or more instructions stored in the memory 150. In the memory 150, programs, applications, and data for driving the electronic device 100 may be stored.

The electronic device 100 may include a distance sensor 160. The distance sensor 160 may sense a distance between the electronic device 100 and a projection surface. For example, the distance sensor 160 may be a Time of Flight (ToF) sensor. The distance sensor 160 may emit a light to the front surface direction of the electronic device 100. The front surface direction. The front surface direction may mean a direction wherein an image is projected by the projection part 120. When a light is reflected from the projection surface and received, the distance sensor 160 may sense a distance between the electronic device 100 and the projection surface based on the time when the light was received.

The communication interface 170 may communicate with an external device such as a server, a mobile device, etc. through an ambient access point (AP). The access point (AP) may connect a local area network (LAN) to which the electronic device 100 or a mobile device is connected to a wide area network (WAN) to which a server is connected. The electronic device 100 may be connected to the server through the wide area network (WAN). Also, the communication interface 170 may perform Device to Device (D2D) communication with an external device. For example, the communication interface 170 may perform near field communication with an external device not via the access point.

The communication interface 170 may transmit or receive data with an external device. The communication interface 170 may include a wireless communication module or a wired communication module. The communication module may be implemented in a form of at least one hardware chip.

The wireless communication module may be a module that communicates with an external device wirelessly. For example, the wireless communication module may include at least one of a Wi-Fi module, a Bluetooth module, or an infrared communication module. However, the wireless communication module is not limited to these examples, and it may include communication modules that communicate according to various wireless communication standards such as Long Term Evolution (LTE), LTE Advanced (LTE-A), 4th Generation (4G), 5th Generation (5G), etc.

The wired communication module may be a module that communicates with an external device via wire. For example, the wired communication module may include at least one of a local area network (LAN) module or an Ethernet module.

The input/output interface 180 may communicate with an external device. The input/output interface 180 may transmit data to an external device, or receive data from an external device. The input/output interface 180 may include a connector 103. For example, the input/output interface 180 may include at least one wired input/output interface among a high definition multimedia interface (HDMI), a universal serial bus (USB), a USB C-type, and a display port (DP).

The input/output interface 180 may be supplied with power from the outside. For example, the input/output interface 180 may be supplied with power from an external battery through an HDMI, a USB, a USB C-type, etc., or may be supplied with power from a consent through a power adaptor. Also, the electronic device 100 may be supplied with power from an external device (e.g., a laptop, a monitor, etc.) through a DP.

The speaker 190 may output an audio signal. The speaker 190 may include an audio output module. For example, the audio output module may include a plurality of audio output units. The plurality of audio output units may be arranged symmetrically inside the main body 101, and output audio signals in directions of 360 degrees.

The camera 195 may obtain an image by performing photographing. For example, the camera 195 may obtain an image that photographed a projection surface by photographing the front surface direction of the electronic device 100. The camera 195 may include at least one lens, an image sensor, an image signal processor, etc.

Although not illustrated in FIG. 2B, the electronic device 100 may include a battery. The battery may be provided inside the main body 101, and supply power to the components of the electronic device 100. For example, the battery may include a primary battery or a secondary battery that can be charged.

Meanwhile, hereinafter, the at least one processor 140 will be referred to as the processor 140, for the convenience of explanation.

The processor 140 identifies whether an external light exists around the electronic device 100 based on an illumination value sensed at the illumination sensor 130. The processor 140 controls the projection part 120 to project an image including a plurality of color patches on a projection surface. Then, the processor 140 performs color calibration of an output image based on whether an external light exists around the electronic device 100 and a color of a color patch selected based on a user input among the plurality of color patches, and controls the projection part 120 to project the output image for which color calibration has been performed.

An output image may be an image content provided to the user. The processor 140 may control the projection part 120 to project an output image by using an image signal received from an external device through the communication interface 170 or the input/output interface 180.

Hereinafter, the color calibration method of an output image will be described in more detail. Meanwhile, in the disclosure, correcting R, G, B values of an output image may include correcting R, G, B values of each of a plurality of pixels constituting the output image.

The processor 140 may identify whether an external light exists around the electronic device 100 based on an illumination value sensed at the illumination sensor 130.

An external light may mean a light output from the outside of the electronic device 100 such as a sunlight and a light output from a lighting. The processor 140 may identify whether an external light exists around the electronic device 100 based on an illumination value sensed at the illumination sensor 130. For example, in case an illumination value sensed at the illumination sensor 130 is smaller than or equal to a predetermined value, the processor 140 may identify that an external light does not exist around the electronic device 100, and in case an illumination value sensed at the illumination sensor 130 is larger than the predetermined value, the processor 140 may identify that an external light exists around the electronic device 100. The predetermined value may be 0 (lux) or a value close to 0, but is not limited to these examples. The predetermined value may be set or changed according to a user input.

If it is identified that an external light does not exist, the processor 140 may control the projection part 120 to project an image including a plurality of color patches on a projection surface in the first brightness.

The plurality of color patches may have different colors from one another. Also, the color patches may be squares. However, the color patches are not limited to these examples, and they may be various shapes such as rectangles, circles, or triangles, etc.

The first brightness may be the maximum brightness of the electronic device 100. That is, the first brightness may be the maximum brightness of an image that can be projected by the electronic device 100. The brightness may be determined based on the intensity of a light output from the electronic device 100.

The processor 140 may receive a user input selecting a color patch that is seen by the user in the first color among the plurality of color patches through the user interface 110.

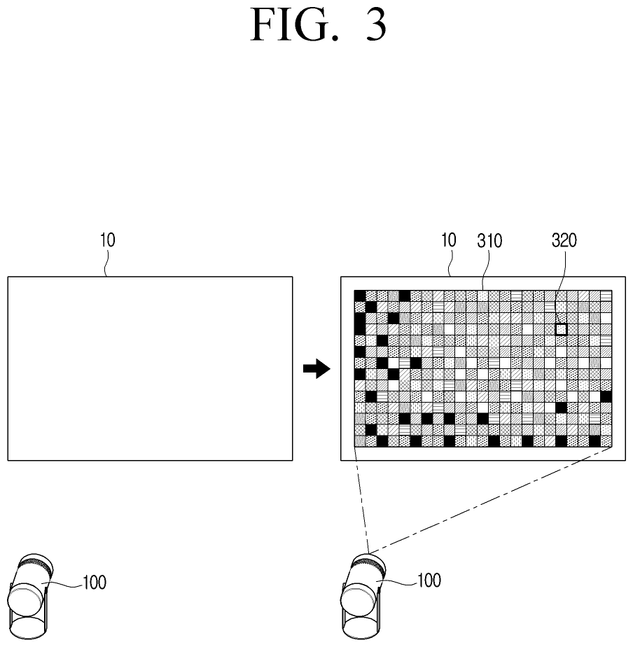

For example, the processor 140 may control the projection part 120 to project a graphical user interface (GUI) for selecting a color patch. The processor 140 may display a GUI by using various methods such as displaying a rim portion of a color patch in a different color, or highlighting and displaying a color patch, or adding a specific image such as an arrow, a cursor, an indicator, etc. The GUI may be moved according to a user input, and a color patch on which the GUI is located among the plurality of color patches may be selected according to a user input. For example, as in FIG. 3, an image including the plurality of color patches 310 and a GUI 320 for selecting one of the plurality of color patches 310 may be displayed on the projection surface 10.

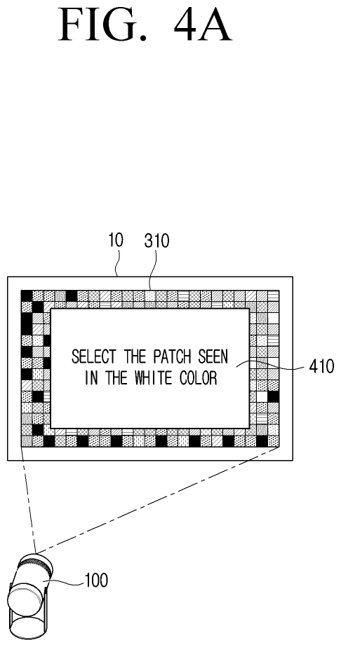

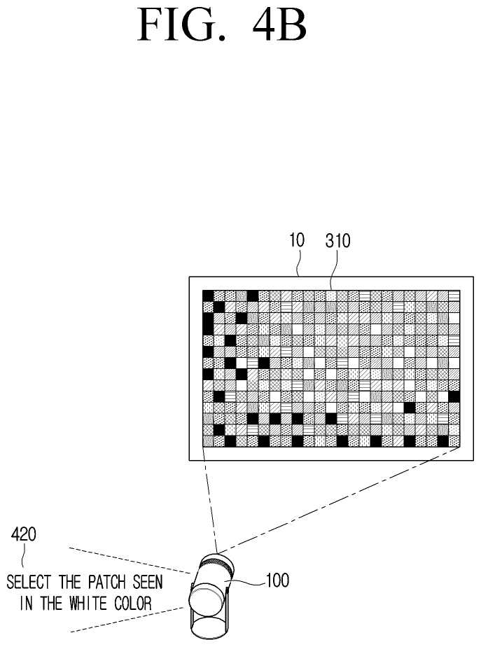

The first color may be a white color. The processor 140 may provide a user interface (UI) for guiding the user to select a color patch seen in the white color. For example, as in FIG. 4A, the processor 140 may control the projection part 120 to project a text 410 such as “Select the color patch seen in the white color.” As another example, as in FIG. 4B, the processor 140 may output a voice signal 420 such as “Select the color patch seen in the white color” through the speaker 190. Accordingly, the user may select the color patch seen in the white color among the plurality of color patches by using the GUI 320.

If a user input selecting the color patch that is seen by the user in the first color among the plurality of color patches is received, the processor 140 may perform color calibration of an output image by correcting the R, G, B values of the output image based on the ratio values of the R, G, B values of the color patch. Then, the processor 140 may control the projection part 120 to project the output image for which color calibration has been performed.

For example, a case wherein the R, G, B values of a color patch selected according to a user input are Cr, Cg, Cb is assumed.

The processor 140 may identify the maximum value among the R, G, B values of the color patch. For example, the processor 140 may identify a MaxColor which is the largest value among Cr, Cg, Cb. Here, MaxColor=max (Cr, Cg, Cb).

Then, the processor 140 may identify the ratio values of the R, G, B values of the color patch by dividing the R, G, B values of the color patch by the maximum value. The ratio values CRr, CRg, CRb may be values for correcting the R, G, B values of an output image. For example, the processor 140 may identify the ratio values CRr, CRg, CRb by dividing Cr, Cg, Cb by MaxColor. Here, CRr=Cr/MaxColor, CRg=Cg/MaxColor, CRb=Cb/MaxColor.

Then, the processor 140 may correct the R, G, B values of the output image by multiplying the R, G, B values of the output image by the ratio values. For example, a case wherein the R, G, B values of the output image are iR, iG, iB is assumed. The processor 140 may correct the R, G, B values of the output image by multiplying iR by CRr, multiplying iG by CRg, and multiplying iB by CRb. The corrected R value may be oR(=iR×CRr), the corrected G value may be oG(=iG×CRg), and the corrected B value may be oB(=iB×CRb).

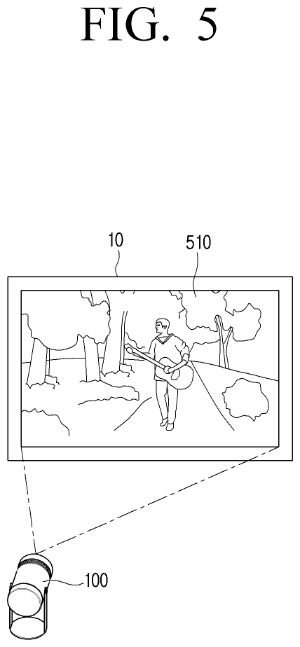

Then, the processor 140 may control the projection part 120 to project an image by using the corrected R, G, B values. The projection part 120 may project the output image having the corrected R, G, B values on the projection surface. Accordingly, as in FIG. 5, an image 510 of which colors have been corrected may be displayed on the projection surface 10.

As described above, the electronic device 100 may correct an output image by identifying the maximum color value among the color values (R, G, B values) of a color patch that is seen by the user in the white color on a projection surface, and reducing the color values of the remaining colors excluding the color having the maximum color value in the output image based on the ratios of the remaining color values to the maximum color value. Accordingly, the colors of the output image may be corrected (e.g., shifted) to the color direction of the color patch that is seen by the user in the white color on the projection surface. As described above, according to the disclosure, a white balance can be adjusted to fit a user's perspective easily and conveniently without a separate measurement equipment, and influence that the color of a projection surface exerts on an image projected on the projection surface can thereby be minimized.

Meanwhile, in case an external light exists, an image projected on a projection surface may be influenced by the external light as well as the color of the projection surface. As the intensity of an external light reflected on a projection surface is regular, influence exerted by the external light on a projected image may vary according to the brightness of the image projected on the projection surface. For example, influence that a dark image receives by an external light may be relatively larger than a bright image. The electronic device 100 according to the disclosure may perform color calibration of an output image by considering this, and more detailed explanation in this regard will be described below.

If it is identified that an external light exists, the processor 140 may control the projection part 120 to project an image including a plurality of color patches on a projection surface in the first brightness.

The plurality of color patches may have different colors from one another. The color patches may be squares. However, the color patches are not limited to these examples, and they may be various shapes such as rectangles, circles, or triangles, etc.

For example, the first brightness may be the maximum brightness of the electronic device 100. The first brightness may be the maximum brightness of an image that can be projected by the electronic device 100. However, the first brightness is not limited to this example, and the first brightness may include a relatively high brightness value within a brightness range of an image that can be projected by the electronic device 100.

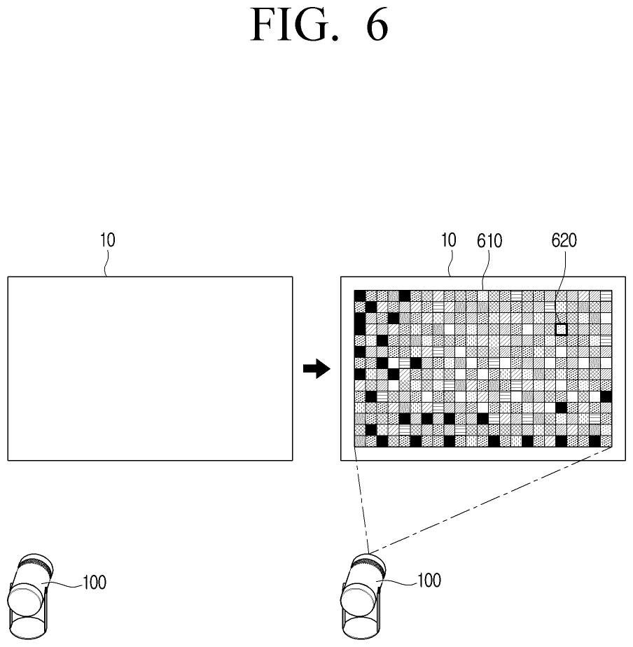

The processor 140 may receive a user input selecting a color patch that is seen by the user in the first color among the plurality of color patches through the user interface 110. For example, the processor 140 may control the projection part 120 to project a GUI for selecting a color patch. The GUI may be moved according to a user input, and a color patch on which the GUI is located among the plurality of color patches may be selected according to a user input. For example, as in FIG. 6, an image including the plurality of color patches 610 and a GUI 620 for selecting one of the plurality of color patches 610 may be displayed on the projection surface 10.

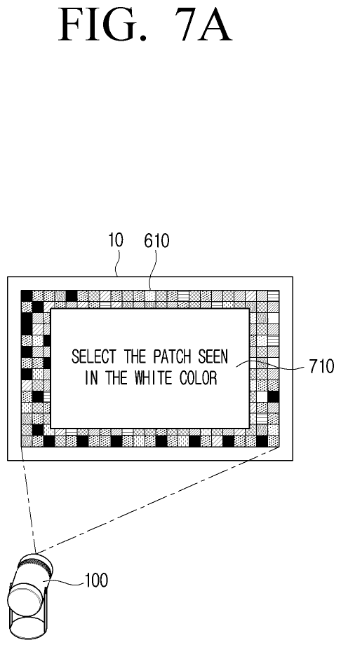

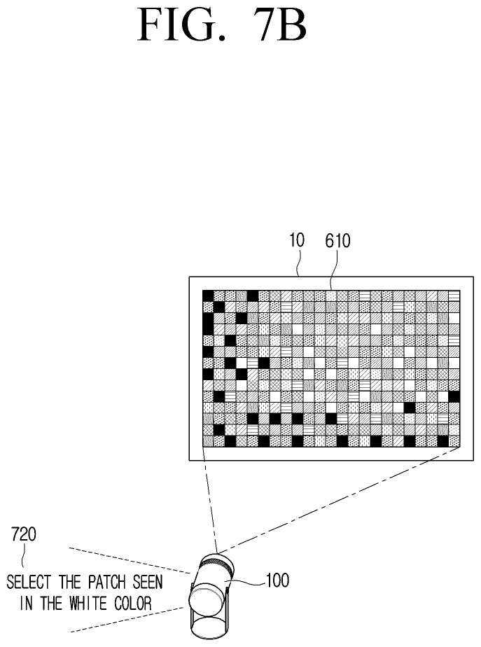

The first color may be a white color. The processor 140 may provide a UI for guiding to select a color patch seen in the white color to the user. For example, as in FIG. 7A, the processor 140 may control the projection part 120 to project a text 710 such as “Select the color patch seen in the white color.” As another example, as in FIG. 7B, the processor 140 may output a voice signal 720 such as “Select the color patch seen in the white color” through the speaker 190. Accordingly, the user may select the color patch seen in the white color among the plurality of color patches by using the GUI 620.

Also, the processor 140 may control the projection part 120 to project an image including a plurality of color patches on the projection surface in the second brightness.

The plurality of color patches may have different colors from one another. Also, the color patches may be squares. However, the color patches are not limited to these examples, and they may be various shapes such as rectangles, circles, or triangles, etc.

The second brightness may be lower than the first brightness. Accordingly, the brightness of a color patch included in an image in the second brightness may be lower than the brightness of a color patch included in an image in the first brightness. For example, when the brightness is expressed as 0-255, the second brightness may be 64. However, this is merely an example, and the second brightness may include dark brightness values such as 128, 96, etc.

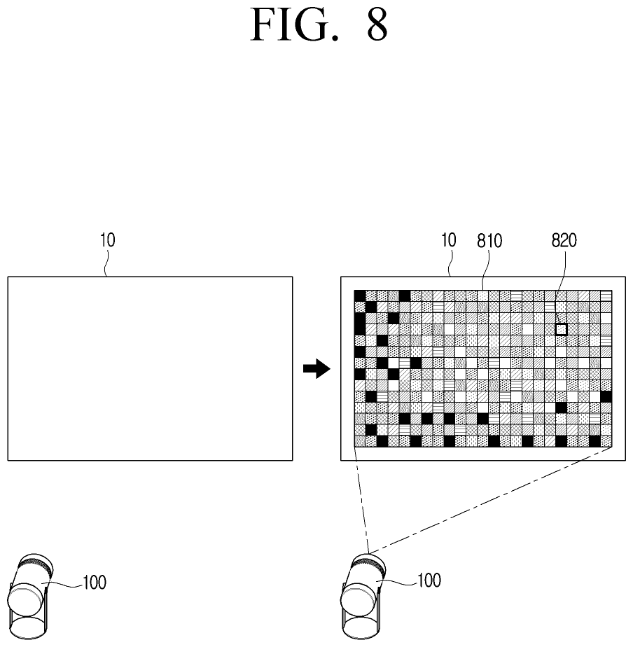

The processor 140 may receive a user input selecting a color patch that is seen by the user in the second color among the plurality of color patches through the user interface 110. For example, the processor 140 may control the projection part 120 to project a GUI for selecting a color patch. The GUI may be moved according to a user input, and a color patch on which the GUI is located among the plurality of color patches may be selected according to a user input. For example, as in FIG. 8, an image including the plurality of color patches 810 and a GUI 820 for selecting one of the plurality of color patches 810 may be displayed on the projection surface 10.

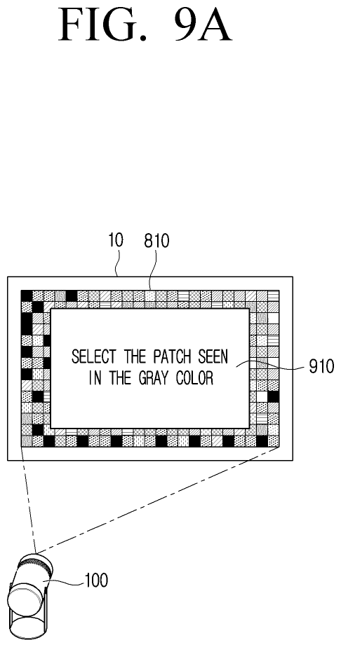

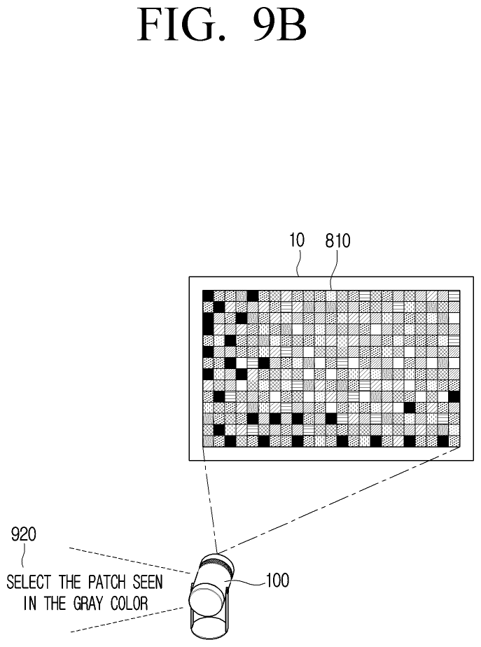

The second color may be a gray color. The processor 140 may provide a UI for guiding to select a color patch seen in the gray color to the user. For example, as in FIG. 9A, the processor 140 may control the projection part 120 to project a text 910 such as “Select the color patch seen in the gray color.” As another example, as in FIG. 9B, the processor 140 may output a voice signal 920 such as “Select the color patch seen in the gray color” through the speaker 190. Accordingly, the user may select the color patch seen in the gray color among the plurality of color patches by using the GUI 820.

If a user input selecting the first color patch that is seen by the user in the first color among a plurality of color patches included in an image in the first brightness is received, the processor 140 may identify the first ratio values of the R, G, B values of the first color patch.

For example, a case wherein the R, G, B values of the first color patch selected according to a user input among the plurality of color patches included in an image in the first brightness are wCr, wCg, wCb is assumed.

The processor 140 may identify the first maximum value among the R, G, B values of the first color patch. For example, the processor 140 may identify wMaxColor which is the biggest value among wCr, wCg, wCb. Here, wMaxColor=max (wCr, wCg, wCb).

Then, the processor 140 may identify the ratio values of the R, G, B values of the first color patch by dividing the R, G, B values of the first color patch by the first maximum value. For example, the processor 140 may identify the first ratio values wCRr, wCRg, wCRb by dividing wCr, wCg, wCb by wMaxColor. Here, wCRr=wCr/wMaxColor, wCRg=wCg/wMaxColor, wCRb=wCb/wMaxColor.

If a user input selecting the second color patch that is seen by the user in the second color among a plurality of color patches included in an image in the second brightness is received, the processor 140 may identify the second ratio values of the R, G, B values of the second color patch.

For example, a case wherein the R, G, B values of the second color patch selected according to a user input among the plurality of color patches included in an image in the second brightness are gCr, gCg, gCb is assumed.

The processor 140 may identify the second maximum value among the R, G, B values of the second color patch. For example, the processor 140 may identify gMaxColor which is the biggest value among gCr, gCg, gCb. Here, gMaxColor=max(gCr, gCg, gCb).

Then, the processor 140 may identify the ratio values of the R, G, B values of the second color patch by dividing the R, G, B values of the second color patch by the second maximum value. For example, the processor 140 may identify the second ratio values gCRr, gCRg, gCRb by dividing gCr, gCg, gCb by gMaxColor. Here, gCRr=gCr/gMaxColor, gCRg=gCg/gMaxColor, gCRb=gCb/gMaxColor.

The processor 140 may correct the R, G, B values of an output image based on at least one of the first ratio values or the second ratio values.

The processor 140 may identify the first weight and the second weight based on the maximum value, the first maximum value, and the second maximum value among the R, G, B values of an output image. For example, a case wherein the R, G, B values of an output image are iR, iG, iB is assumed. The processor 140 may identify iMax which is the biggest value among iR, iG, iB. Here, iMax=max(iR, iG, iB). Then, the processor 140 may calculate the first weight wWeight and the second weight gWeight based on iMax, wMaxColor, gMaxColor. Here, wWeight=(iMax−gMaxColor)/(wMaxColor−gMaxColor), gWeight=(wMaxColor−iMax)/(wMaxColor−gMaxColor).

If the second maximum value is smaller than or equal to the maximum value among the R, G, B values of the output image, the processor 140 may perform color calibration of the output image by correcting the R, G, B values of the output image based on the first ratio values to which the first weight is applied and the second ratio values to which the second weight is applied. For example, the processor 140 may identify the ratio values CRr, CRg, CRb for correcting the R, G, B values of the output image by adding the first ratio values multiplied by the first weight and the second ratio values multiplied by the second weight. Here, CRr=(wWeight×wCRr)+(gWeight×gCRr), and CRg=(wWeight×wCRg)+(gWeight×gCRg), and CRb=(wWeight×wCRb)+(gWeight×gCRb).

Then, the processor 140 may correct the R, G, B values of the output image by multiplying the R, G, B values of the output image by the ratio values. For example, a case wherein the R, G, B values of the output image are iR, iG, iB is assumed. The processor 140 may correct the R, G, B values of the output image by multiplying iR by CRr, multiplying iG by CRg, and multiplying iB by CRb. The corrected R value may be oR(=iR×CRr), the corrected G value may be oG(=iG×CRg), and the corrected B value may be oB(=iB×CRb).

If the second maximum value is larger than the maximum value among the R, G, B values of the output image, the processor 140 may perform color calibration of the output image by correcting the R, G, B values of the output image based on the second ratio values. For example, the processor 140 may identify that the second ratio values are the ratio values CRr, CRg, CRb for correcting the R, G, B values of the output image.

Then, the processor 140 may correct the R, G, B values of the output image by multiplying the R, G, B values of the output image by the ratio values. For example, a case wherein the R, G, B values of the output image are iR, iG, iB is assumed. The processor 140 may correct the R, G, B values of the output image by multiplying iR by CRr, multiplying iG by CRg, and multiplying iB by CRb. The corrected R value may be oR(=iR×CRr), the corrected G value may be oG(=iG×CRg), and the corrected B value may be oB(=iB×CRb).

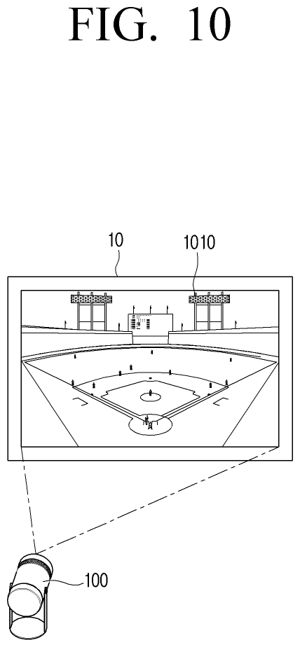

Then, the processor 140 may control the projection part 120 to project an image by using the corrected R, G, B values. The projection part 120 may project the output image having the corrected R, G, B values on the projection surface. Accordingly, as in FIG. 10, an image 1010 of which colors have been corrected may be displayed on the projection surface 10.

As described above, in case an external light does not exist, the electronic device 100 may project a color patch of a high brightness on a projection surface, and perform color calibration of an output image by using ratio values among color values of a color patch that is seen by the user in the white color on the projection surface. However, in case an external light exists, influence exerted by the external light on a projected image may vary according to the brightness of the image projected on the projection surface. Accordingly, in case an external light exists, the electronic device 100 may additionally project a color patch of a low brightness on the projection surface. Then, the electronic device 100 may additionally identify ratio values of color values of a color patch that is seen by the user in the gray color among color patches of a low brightness projected on the projection surface, and perform color calibration of the output image by using the ratio values among the color values of the color patches that are respectively seen by the user in the white and gray colors according to the brightness of the output image. Accordingly, influence exerted by the external light on the image projected on the projection surface can be minimized.

Meanwhile, in the aforementioned example, it was explained that the electronic device 100 performs color calibration of an output image based on ratio values of R, G, B values of a color patch selected based on a user input. However, this is merely an example, and the electronic device 100 may perform color calibration of an output image based on color coordinates of a color patch.

For example, if it is identified that an external light does not exist, the processor 140 may identify a conversion matrix based on color coordinates of the white color and color coordinates of a color patch selected based on a user input. The color coordinates of the color patch may mean coordinate values indicating the colors of the color patch within a CIE chromaticity diagram (e.g., a CIE1931 chromaticity diagram or a CIE1976 chromaticity diagram), and the color coordinates of the white color may mean coordinate values indicating the white color within the CIE chromaticity diagram. For example, a case wherein the color coordinates of a color patch are (x, y), and the color coordinates of the white color are (x_{w}, y_{w}) is assumed. The processor 140 may convert the color coordinates of the color patch into XYZ values, and convert the color coordinates of the white color into XYZ values. The XYZ values may be tristimulus values. Here, x=X/(X+Y+Z), y=Y/(X+Y+Z), z=Z/(X+Y+Z)=1−x−y.

Then, the processor 140 may identify a conversion matrix based on a formula 1. The conversion matrix may be a matrix that is used in color calibration of an image when the image is projected on a colored projection surface, such that the white color of the projected image can be seen as the white color to the user.

$$[ \begin{matrix}X \\ Y \\ Z\end{matrix} ] = M [ \begin{matrix}{X}_{w} \\ {Y}_{w} \\ {Z}_{w}\end{matrix} ] \qquad [ Formula 1 ]$$

Here, M is the conversion matrix, and X, Y, Z values are the X, Y, Z values obtained by the color coordinates of the color patch, and X_{w}, Y_{w}, Z_{w} values are the X, Y, Z values obtained by the color coordinates of the white color.

The processor 140 may perform color calibration of the output image based on the conversion matrix. For example, the processor 140 may convert the R, G, B values of the output image based on the conversion matrix.

The XYZ color space may be obtained from the RGB color space through linear conversion. For example, the values of an XYZ color space and an RGB color space may be converted with each other based on a formula 2.

$$[ \begin{matrix}X \\ Y \\ Z\end{matrix} ] = [ \begin{matrix}0.4124564 & 0.3575761 & 0.1804375 \\ 0.2126729 & 0.7151522 & 0.072175 \\ 0.0193339 & 0.119192 & 0.9503041\end{matrix} ] [ \begin{matrix}R \\ G \\ B\end{matrix} ] \qquad [ Formula 2 ]$$

The processor 140 may convert the R, G, B values of the output image into XYZ values based on the formula 2. Then, as in the formula 3, the processor 140 may convert the XYZ values of the output image by applying the XYZ values of the output image to the conversion matrix.

$$[ \begin{matrix}{X}^{′} \\ {Y}^{′} \\ {Z}^{′}\end{matrix} ] = M [ \begin{matrix}X \\ Y \\ Z\end{matrix} ] \qquad [ Formula 3 ]$$

Here, M may be the conversion matrix, and X, Y, Z values may be the XYZ values of the image.

The processor 140 may correct the RGB values of the output image by re-converting the converted XYZ values (the X′, Y′, Z′ values in the formula 3) into RGB values based on the formula 2. Then, the processor 140 may control the projection part 120 to project the output image by using the corrected RGB values. The projection part 120 may project the output image having the corrected RGB values on the projection surface.

Meanwhile, in the aforementioned example, it was explained that, in case an external light exists, the electronic device 100 projects a color patch of a low brightness on a projection surface, and identifies R, G, B values (gCr, gCg, gCb) of a color patch selected based on a user input. However, this is merely an example, and the electronic device 100 may calculate (or predict) the intensity of a light of the electronic device 100 on a projection surface, and identify the reflection characteristic (the color) of the projection surface based on the intensity of the light and the intensity of an external light, and identify the R, G, B values of a color patch based on the reflection characteristic of the projection surface.

For example, in the memory 150, information on R, G, B values (Pr, Pg, Pb) of a light measured on a screen that is distanced from the electronic device 100 by a reference distance, when the light is projected from the electronic device 100 in the first brightness, may be stored. The first brightness may be the maximum brightness of the electronic device 100. The R, G, B values of a light may be experimentally measured, and may be stored in the memory 150 when the electronic device 100 is manufactured.

If it is assumed that an external light of the same intensity as an external light received at the electronic device 100 is incident into a projection surface, when the electronic device 100 projects a light on the projection surface in the first brightness, the intensity of the light on the projection surface may be calculated based on the distance between the electronic device 100 and the projection surface, and Pr, Pg, Pb. The intensity of the light may be inverse proportional to the distance. Accordingly, the processor 140 may measure the distance between the electronic device 100 and the projection surface through the distance sensor 160, and identify the R, G, B values of the light corresponding to the distance between the electronic device 100 and the projection surface by using the measured distance, the reference distance, and Pr, Pg, Pb. Here, the R, G, B values of the light corresponding to the distance between the electronic device 100 and the projection surface may be the R, G, B values (PPr, PPg, PPb) of the light on the projection surface when the electronic device 100 projects the light on the projection surface in the first brightness.

The processor 140 may obtain the R, G, B values (Lr, Lg, Lb) of the external light received at the illumination sensor 130 by using the illumination sensor 130. The illumination sensor 130 may include an RGB color sensor.

Then, the processor 140 may identify ratio values SPr, SPg, SPb of the reflection characteristic regarding R, G, B of the projection surface. Here, min(Tr,Tg,Tb)/Tr=wCRr, min(Tr,Tg,Tb)/Tg=wCRg, min(Tr,Tg,Tb)/Tb=wCRb. Here, wCr, wCg, wCb may be the R, G, B values of the first color patch selected according to a user input among the plurality of color patches included in the image in the first brightness. Accordingly, the processor 140 may calculate SPr, SPg, SPb based on the above formula.

Then, the processor 140 may identify the R, G, B (gCr, gCg, gCb) of the color patch based on the ratio values of the reflection characteristic. For example, if a case wherein the brightness of the color patch is 64 is assumed, it may be gCr=64×min(Tr,Tg,Tb)/Tr, gCg=64×min(Tr,Tg,Tb)/Tg, gCb=64×min(Tr,Tg,Tb)/Tb. Accordingly, the processor 140 may identify the R, G, B values (gCr, gCg, gCb) of the color patch.

Meanwhile, the processor 140 may provide a color calibration result to the user before projecting an output image.

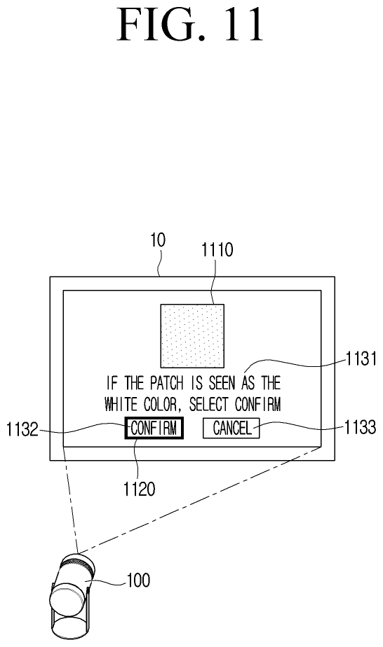

For example, the processor 140 may identify the R, G, B values of the white color based on ratio values CRr, CRg, CRb for correcting the R, G, B values of an output image, and control the projection part 120 to project an image including a color patch having the corrected R, G, B values. Then, the processor 140 may control the projection part 120 to perform color calibration of the output image and project the image, or control the projection part 120 to project a plurality of color patches again according to a user input. For example, as in FIG. 11, an image including a color patch 1110 having corrected R, G, B values and a GUI 1120 may be displayed on a projection surface 10. Also, the image may include a text 1131 for checking whether the color patch 1110 is seen as the white color to the user. In case the color patch 1110 projected on the projection surface 10 is seen as the white color, the user may select “confirm 1132” by using the GUI 1120. If a user input selecting the “confirm 1132” is received through the user interface 110, the processor 140 may correct the colors of the output image, and project the output image of which colors have been corrected on the projection surface 10. Meanwhile, in case the color patch 1110 projected on the projection surface 10 is not seen as the white color, the user may select “cancel 1133” by using the GUI 1120. If a user input selecting the “cancel 1133” is received through the user interface 110, the processor 140 may project a plurality of color patches again on the projection surface 10.

Meanwhile, as colors of color patches are diverse, and the user may be influenced by the color of an ambient color patch in selecting a color patch, the user may not easily select which color patch is seen as the white color among the plurality of color patches. Accordingly, the electronic device 100 may sequentially project color patches on a projection surface such that the user can select a color patch seen as the white color more easily.

For example, the processor 140 may control the projection part 120 to project an image including a plurality of first color patches on a projection surface.

If a user input selecting a color patch among the plurality of first color patches is received through the user interface 110, the processor 140 may obtain a plurality of second color patches by adjusting the chroma (or the color saturation) of the color of the color patch. Adjusting the chroma may mean adjusting the degree of depth of the color. Then, the processor 140 may control the projection part 120 to project an image including the plurality of second color patches on the projection surface, and if a user input selecting a color patch among the plurality of second color patches is received through the user interface 110, the processor 140 may perform color calibration of the output image based on the color of the color patch.

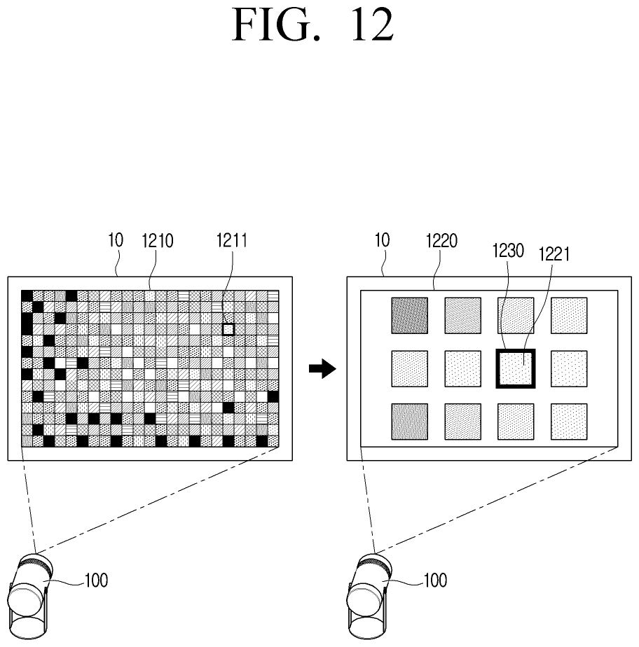

For example, as in FIG. 12, if a user input for selecting a yellow color patch 1211 among a plurality of color patches 1210 is received through the user interface 110, the processor 140 may obtain a plurality of color patches 1220 in yellow-based colors from a light yellow color to a deep yellow color by adjusting the color saturation of the yellow color. The processor 140 may control the projection part 120 to project an image including the plurality of color patches 1220 and a GUI 1230 for selecting one of the plurality of color patches 1220 on the projection surface 10. If a user input for selecting the color patch 1221 among the plurality of color patches 1220 is received through the user interface 110, the processor 140 may perform color calibration of the output image by using the color value of the color patch 1221.

Meanwhile, the colors of the plurality of color patches may be determined in advance. However, the colors are not limited to this example, and the processor 140 may determine the colors of the plurality of color patches based on the color of a projection surface. For example, the processor 140 may obtain an image including a projection surface by performing photographing through the camera 195, and identify the colors of the plurality of color patches based on the color of the projection surface included in the image. Specifically, the processor 140 may identify a color on the opposite side of the color coordinates of the color of the projection surface based on the color coordinates of the white color within the chromaticity diagram, and identify the colors of the plurality of color patches by adjusting the chroma of the identified color.

For example, the processor 140 may identify a wall surface in an image obtained through the camera 195 by using an object recognition algorithm. A deep learning model may be used in object recognition. The processor 140 may convert the RGB values of the wall surface into XYZ values, and identify the color coordinates of the color of the wall surface by using the XYZ values. The processor 140 may generate a virtual line passing through the color coordinates of the white color from the color coordinates of the color of the wall surface within the chromaticity diagram, and identify the color of the area which the virtual line is toward within the chromaticity diagram.

For example, a case wherein the color of a wall surface is blue is assumed. Referring to the CIE chromaticity diagram, a yellow area (e.g., yellow or greenish yellow) is located on the opposite side of the area occupied by the blue color based on the color coordinates of the white color within the chromaticity diagram. Accordingly, the processor 140 may identify that yellow-based colors are the colors of the plurality of color patches, and control the projection part 120 to project an image including a plurality of color patches consisting of yellow-based colors on the projection surface.

If the color of a color patch is determined in consideration of the color of a projection surface as above, there is high possibility that the color patch projected on the projection surface is seen as a white-based color to the user. Accordingly, the user can select a color patch seen as the white color more easily.

Meanwhile, if a lot of color patches are displayed on one screen, the user may not easily select a color patch among the plurality of color patches. According to the disclosure, the electronic device 100 may display color patches in various sizes or shapes.

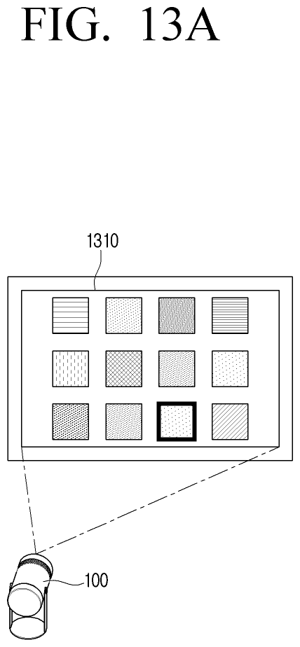

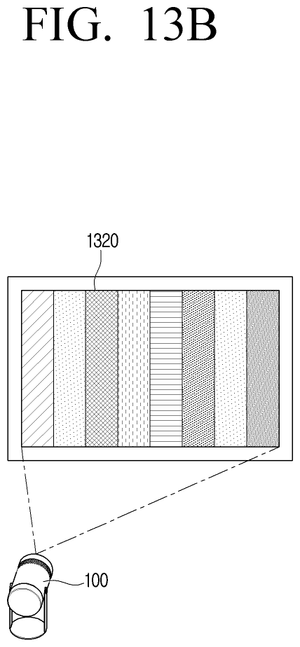

As in FIG. 3, FIG. 6, and FIG. 8 described above, the sizes of color patches may be the first size. As another example, as in FIG. 13A, the sizes of the color patches 1310 may be the second size. The second size may be larger than the first size. Also, as in FIG. 13B, the shapes of the color patches 1320 may be rectangles. Also, although not illustrated in the drawing, the shapes of the color patches may be various shapes such as circles or triangles, etc.

The processor 140 may change the sizes or the shapes of color patches. For example, if a user input for changing the sizes of the color patches is received through the user interface 110 while an image including a plurality of color patches is projected on a projection surface, the processor 140 may control the projection part 120 to project the image including the plurality of color patches of which sizes have been respectively changed. The feature that a size has been changed may include that the size has become larger or has become smaller. Accordingly, the user can select a color patch more easily.

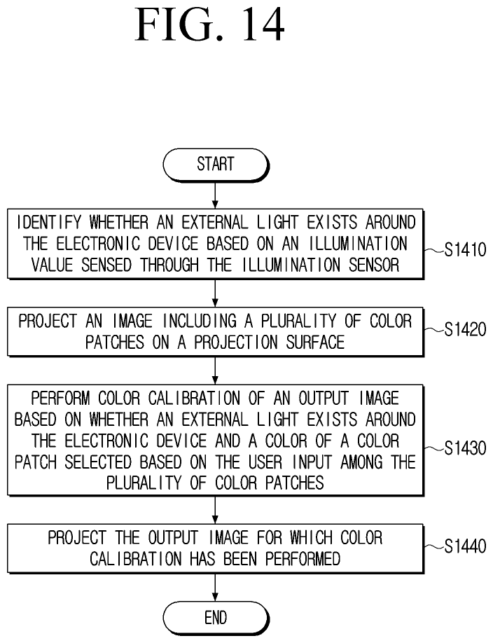

FIG. 14 is a flow chart for illustrating a color calibration method of an electronic device according to an embodiment of the disclosure.

It is identified whether an external light exists around the electronic device based on an illumination value sensed through an illumination sensor in operation S1410.

An image including a plurality of color patches is projected on a projection surface in operation S1420.

Color calibration of an output image is performed based on whether an external light exists around the electronic device and a color of a color patch selected based on the user input among the plurality of color patches in operation S1430.

The output image for which color calibration has been performed is projected in operation S1440.

In the operation S1420, if it is identified that the external light does not exist, the image including the plurality of color patches may be projected on the projection surface in first brightness. In the operation S1430, if a user input selecting a color patch that is seen by a user in a first color among the plurality of color patches is received, the color calibration of the output image may be performed by correcting R, G, B values of the output image based on ratio values of R, G, B values of the color patch.

In the operation S1430, a maximum value among the R, G, B values of the color patch may be identified, the ratio values of the R, G, B values of the color patch may be identified by dividing the R, G, B values of the color patch by the maximum value, and the R, G, B values of the output image may be corrected by multiplying the R, G, B values of the output image by the identified ratio values.

The first brightness may include the maximum brightness of the electronic device. Also, the first color may include a white color.

In the operation S1420, if it is identified that the external light exists, the image including the plurality of color patches may be projected on the projection surface in first brightness and the image including the plurality of color patches may be projected on the projection surface in second brightness. In the operation S1430, if a user input selecting a first color patch that is seen by a user in a first color among the plurality of color patches included in the image of the first brightness is received, first ratio values of R, G, B values of the first color patch may be identified, and if a user input selecting a second color patch that is seen by a user in a second color among the plurality of color patches included in the image of the second brightness is identified, second ratio values of R, G, B values of the second color patch may be identified, and the color calibration of the output image may be performed by correcting the R, G, B values of the output image based on at least one of the first ratio values or the second ratio values.

The first brightness may include the maximum brightness of the electronic device, and the second brightness may be lower than the first brightness. Also, the first color may include a white color, and the second color may include a gray color.

Meanwhile, in the operation of identifying the first ratio values, a first maximum value among the R, G, B values of the first color patch may be identified, and the first ratio values of the R, G, B values of the first color patch may be identified by dividing the R, G, B values of the first color patch by the first maximum value. Also, in the operation of identifying the second ratio values, a second maximum value among the R, G, B values of the second color patch may be identified, and the second ratio values of the R, G, B values of the second color patch may be identified by dividing the R, G, B values of the second color patch by the second maximum value.

In the operation S1430, a first weight and a second weight may be identified based on a maximum value, the first maximum value, and the second maximum value among the R, G, B values of the output image. Also, in the operation S1430, if the second maximum value is smaller than or equal to the maximum value, the color calibration of the output image may be performed by correcting the R, G, B values of the output image based on the first ratio values to which the first weight was applied and the second ratio values to which the second weight was applied. In addition, in the operation S1430, if the second maximum value is larger than the maximum value, the color calibration of the output image may be performed by correcting the R, G, B values of the output image based on the second ratio values.

Meanwhile, in the color calibration method according to the disclosure, if a user input selecting a color patch among a plurality of first color patches is received, a plurality of second color patches may be obtained by adjusting the chroma of the color of the color patch, and an image including the plurality of second color patches may be projected on the projection surface. Also, in the operation S1430, if a user input selecting a color patch among the plurality of second color patches is received, the color calibration of the output image may be performed based on the color of the color patch.

Meanwhile, in the color calibration method according to the disclosure, an image including the projection surface may be obtained by performing photographing through the camera, and the colors of the plurality of color patches may be identified based on the colors of the projection surface included in the image.

Meanwhile, according to an embodiment of the disclosure, the aforementioned various embodiments may be implemented as software including instructions stored in machine-readable storage media, which can be read by machines (e.g., computers). The machines refer to devices that call instructions stored in a storage medium, and can operate according to the called instructions, and the devices may include an electronic device according to the aforementioned embodiments (e.g., an electronic device A). In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. Here, the term “non-transitory’ only means that a storage medium does not include signals, and is tangible, but does not indicate whether data is stored in the storage medium semi-permanently or temporarily.

Also, according to an embodiment of the disclosure, a method according to the aforementioned various embodiments may be provided while being included in a computer program product. A computer program product refers to a product, and it can be traded between a seller and a buyer. A computer program product can be distributed on-line in the form of a storage medium that is readable by machines (e.g., a compact disc read only memory (CD-ROM)), or through an application store (e.g., Play Store™). In the case of on-line distribution, at least a portion of a computer program product may be stored in a storage medium such as the server of the manufacturer, the server of the application store, and the memory of the relay server at least temporarily, or may be generated temporarily.

In addition, according to an embodiment of the disclosure, the aforementioned various embodiments may be implemented in a recording medium that can be read by a computer or a device similar to a computer, by using software, hardware, or a combination thereof. In some cases, the embodiments described in this specification may be implemented as a processor itself. According to implementation by software, the embodiments such as processes and functions described in this specification may be implemented as separate software modules. Each of the software modules can perform one or more functions and operations described in this specification.

Meanwhile, computer instructions for performing processing operations of machines according to the aforementioned various embodiments may be stored in a non-transitory computer-readable medium. Computer instructions stored in such a non-transitory computer-readable medium make the processing operations at machines according to the aforementioned various embodiments performed by a specific machine, when the instructions are executed by the processor of the specific machine. A non-transitory computer-readable medium refers to a medium that stores data semi-permanently, and is readable by machines, but not a medium that stores data for a short moment such as a register, a cache, and a memory. As specific examples of a non-transitory computer-readable medium, there may be a CD, a DVD, a hard disc, a blue-ray disc, a USB, a memory card, a ROM, and the like.

Also, each of the components according to the aforementioned various embodiments (e.g., a module or a program) may consist of a singular object or a plurality of objects. Also, among the aforementioned corresponding sub components, some sub components may be omitted, or other sub components may be further included in the various embodiments. Alternatively or additionally, some components (e.g., a module or a program) may be integrated as an object, and perform the functions that were performed by each of the components before integration identically or in a similar manner. Operations performed by a module, a program, or other components according to the various embodiments may be executed sequentially, in parallel, repetitively, or heuristically. Or, at least some of the operations may be executed in a different order or omitted, or other operations may be added.

Also, while preferred embodiments of the disclosure have been shown and described, the disclosure is not limited to the aforementioned specific embodiments, and it is apparent that various modifications can be made by those having ordinary skill in the art to which the disclosure belongs, without departing from the gist of the disclosure as claimed by the appended claims. Further, it is intended that such modifications are not to be interpreted independently from the technical idea or prospect of the disclosure.

What is claimed is:

1. An electronic device comprising:
a projection part;
a user interface;
an illumination sensor; and
at least one processor configured to:
identify whether an external light exists around the electronic device based on an illumination value sensed by the illumination sensor,
control the projection part to project an image including a plurality of color patches on a projection surface,
perform color calibration of an output image based on whether an external light exists around the electronic device and a color of a color patch among the plurality of color patches selected through the user interface, and
control the projection part to project the output image for which the color calibration has been performed.

2. The electronic device of claim 1, wherein
the at least one processor is configured to:
based on identifying that the external light does not exist, control the projection part to project the image including the plurality of color patches on the projection surface in a first brightness, and
based on receiving a user input through the user interface selecting a color patch among the plurality of color patches that is seen by a user in a first color, perform the color calibration of the output image by correcting R, G, B values of the output image based on ratio values of R, G, B values of the selected color patch.

3. The electronic device of claim 2, wherein
the at least one processor is configured to:
identify a maximum value among the R, G, B values of the selected color patch,
identify the ratio values of the R, G, B values of the selected color patch by dividing the R, G, B values of the selected color patch by the identified maximum value, and
correct the R, G, B values of the output image by multiplying the R, G, B values of the output image by the identified ratio values.

4. The electronic device of claim 2, wherein
the first brightness includes a maximum brightness of the electronic device, and
the first color includes a white color.

5. The electronic device of claim 1, wherein
the at least one processor is configured to:
based on identifying that the external light exists, control the projection part to:
project the image as a first image including the plurality of color patches on the projection surface in a first brightness, and
project the image as a second image including the plurality of color patches on the projection surface in a second brightness,
based on receiving a user input through the user interface selecting a first color patch among the plurality of color patches included in the first image that is seen by a user in a first color, identify first ratio values of R, G, B values of the first color patch,
based on receiving a user input through the user interface selecting a second color patch among the plurality of color patches included in the second image that is seen by the user in a second color, identify second ratio values of R, G, B values of the second color patch, and
perform the color calibration of the output image by correcting the R, G, B values of the output image based on at least one of the identified first ratio values or the identified second ratio values.

6. The electronic device of claim 5, wherein
the first brightness includes a maximum brightness of the electronic device,
the second brightness is lower than the first brightness,
the first color includes a white color, and
the second color includes a gray color.

7. The electronic device of claim 5, wherein
the at least one processor is configured to:
identify a first maximum value among the R, G, B values of the first color patch,
identify the first ratio values of the R, G, B values of the first color patch by dividing the R, G, B values of the first color patch by the identified first maximum value,
identify a second maximum value among the R, G, B values of the second color patch, and
identify the second ratio values of the R, G, B values of the second color patch by dividing the R, G, B values of the second color patch by the identified second maximum value.

8. The electronic device of claim 7, wherein
the at least one processor is configured to:
identify a first weight and a second weight based on a maximum value among the R, G, B values of the output image, the first maximum value, and the second maximum value,
based on the second maximum value being smaller than or equal to the maximum value, perform the color calibration of the output image by correcting the R, G, B values of the output image based on the identified first ratio values to which the first weight was applied and the identified second ratio values to which the second weight was applied, and
based on the second maximum value being larger than the maximum value, perform the color calibration of the output image by correcting the R, G, B values of the output image based on the identified second ratio values.

9. The electronic device of claim 1, wherein
the at least one processor is configured to:
based on receiving a user input through the user interface selecting a color patch among a plurality of first color patches, obtain a plurality of second color patches by adjusting a chroma of the color of the selected color patch among the plurality of first color patches,
control the projection part to project an image including the plurality of second color patches on the projection surface, and
based on receiving a user input through the user interface selecting a color patch among the plurality of second color patches, perform the color calibration of the output image based on the color of the selected color patch among the plurality of second color patches.

10. The electronic device of claim 1, further comprising:
a camera,
wherein the at least one processor is configured to:
control the camera to obtain an image including the projection surface, and identify colors of the plurality of color patches based on colors of the projection surface included in the obtained image.

11. A method of performing color calibration of an electronic device including a projection part, a user interface, and an illumination sensor, the method comprising:
identifying whether an external light exists around the electronic device based on an illumination value sensed by the illumination sensor;
projecting an image including a plurality of color patches on a projection surface;
performing color calibration of an output image based on whether an external light exists around the electronic device and a color of a color patch among the plurality of color patches selected through the user interface; and
projecting the output image for which the color calibration has been performed.

12. The method of claim 11, wherein
the projecting the image including the plurality of color patches includes:
based on identifying that the external light does not exist, projecting the image including the plurality of color patches on the projection surface in a first brightness, and the performing the color calibration includes:
based on receiving a user input through the user interface selecting a color patch among the plurality of color patches that is seen by a user in a first color, performing the color calibration of the output image by correcting R, G, B values of the output image based on ratio values of R, G, B values of the selected color patch.

13. The method of claim 12, wherein
the performing the color calibration includes:
identifying a maximum value among the R, G, B values of the selected color patch,
identifying the ratio values of the R, G, B values of the selected color patch by dividing the R, G, B values of the selected color patch by the identified maximum value, and
correcting the R, G, B values of the output image by multiplying the R, G, B values of the output image by the identified ratio values.

14. The method of claim 12, wherein
the first brightness includes a maximum brightness of the electronic device, and
the first color includes a white color.

15. The method of claim 11, wherein
the projecting the image including the plurality of color patches includes:
based on identifying that the external light exists:
projecting the image as a first image including the plurality of color patches on the projection surface in a first brightness, and
projecting the image as a second image including the plurality of color patches on the projection surface in a second brightness, and
the performing the color calibration includes:
based on receiving a user input through the user interface selecting a first color patch among the plurality of color patches included in the first image that is seen by a user in a first color, identifying first ratio values of R, G, B values of the first color patch,
based on receiving a user input through the user interface selecting a second color patch among the plurality of color patches included in the second image that is seen by the user in a second color, identifying second ratio values of R, G, B values of the second color patch, and
performing the color calibration of the output image by correcting the R, G, B values of the output image based on at least one of the identified first ratio values or the identified second ratio values.

16. The method of claim 15, wherein
the first brightness includes a maximum brightness of the electronic device,
the second brightness is lower than the first brightness,
the first color includes a white color, and
the second color includes a gray color.

17. The method of claim 15, wherein
the identifying first ratio values of R, G, B values of the first color patch includes:
identifying a first maximum value among the R, G, B values of the first color patch,
identifying the first ratio values of the R, G, B values of the first color patch by dividing the R, G, B values of the first color patch by the identified first maximum value,
identifying a second maximum value among the R, G, B values of the second color patch, and
identifying the second ratio values of the R, G, B values of the second color patch by dividing the R, G, B values of the second color patch by the identified second maximum value.

18. The method of claim 17, wherein
the performing the color calibration includes:
identifying a first weight and a second weight based on a maximum value among the R, G, B values of the output image, the first maximum value, and the second maximum value,
based on the second maximum value being smaller than or equal to the maximum value, performing the color calibration of the output image by correcting the R, G, B values of the output image based on the identified first ratio values to which the first weight was applied and the identified second ratio values to which the second weight was applied, and
based on the second maximum value being larger than the maximum value, performing the color calibration of the output image by correcting the R, G, B values of the output image based on the identified second ratio values.

19. The method of claim 11, further comprising:
based on receiving a user input through the user interface selecting a color patch among a plurality of first color patches, obtaining a plurality of second color patches by adjusting a chroma of the color of the selected color patch among the plurality of first color patches; and
projecting an image including the plurality of second color patches on the projection surface, and
the performing the color calibration includes:
based on receiving a user input through the user interface selecting a color patch among the plurality of second color patches, performing the color calibration of the output image based on the color of the selected color patch among the plurality of second color patches.

20. The method of claim 11, further comprising:
obtaining an image including the projection surface using a camera; and
identifying colors of the plurality of color patches based on colors of the projection surface included in the obtained image.
